(19) United States
(12) Patent Application Publication
(10) Pub. No.: US 2002/0103936 A1
(43) Pub. Date: Aug. 1, 2002

(54) Method and apparatus for location information transfer and collection in a WAP environment

(76) Inventors: Bashar Jano, Algonquin, IL (US); Slim Souissi, San Diego, CA (US); Garland Phillips, Arlington, TX (US); Casey Hill, Crystal Lake, IL (US)

Correspondence Address: Randall S. Vaas (MCS), Motorola, Inc., Personal Communications Sector, 600 North US Highway 45, Libertyville, IL, 60048, US

(21) Appl. No.: 09/775,036

(22) Filed: Feb. 1, 2001

(51) Int. Cl. G06F 15/16

(52) U.S. Cl. 709/246; 709/249; 709/203

(57) ABSTRACT

A communication network including a plurality of intennediaries in which a request for information is generated by a first intermediary and a response to the request is generated by a second intermediary of the plurality of intermediaries. A location token requesting location information corresponding to the first intermediary is included in one or both of the request and the response, and the request and the response are transmitted between the intermediaries, with location information being inserted within the location token in response to receipt of the location token by certain ones of the plurality of intermediaries.

### FIELD OF THE INVENTION

The present invention relates generally to wireless application protocol networks, and in particular, the present invention relates to collection and transfer of location information across a wireless application protocol network.

### BACKGROUND OF THE INVENTION

The wireless application protocol, commonly referred to as “WAP”, has been promulgated to enable application programs to be written to operate on a wide array of wireless communications networks by providing a world standard for the presentation and delivery of wireless information and telephony services. As a result, various handheld wireless devices, such as mobile phones, pagers, two-way radios, smartphones and communicators utilize WAP to enable simple and fast delivery of relevant information and services to mobile users. Although users of such WAP-enabled devices tend to be moving to different physical locations, so that the devices are typically not fixed at a single location, information is nevertheless transmitted and received in a timely, reliable and secure manner.

Known communication networks typically include a WAP client device transmitting and receiving information from a server through a WAP gateway. In order to receive data information from sources along the internet, a user typically inputs a request to navigate to a uniform resource locator (URL) associated with the desired data information to the WAP client device. For example, in order to display a website associated with information relating to gas stations, a URL identifying the website is input to the WAP client device. The WAP client device utilizes the URL to build a request in a binary format, and transmits the request to the WAP gateway, which then decodes the binary request and builds a hypertext transfer protocol (HTTP) request, adding additional headers not included in the original request if needed. The HTTP request is then forwarded by the WAP gateway to the server device. Upon receiving the request, the server composes and transmits an HTTP response, which may include, for example, information gathering content requesting input from the user as to what information is desired.

Since certain information, such as a request to locate the nearest gas station, for example, require that the current location of the WAP client device be obtained, problems relating to the location and transfer of location information across the network have arisen. Ih order to establish the location information, current techniques involve sending a script to a client device. Execution of the script by the client device causes the client device to determine its location, for example, by either accessing an external GPS receiver, reading the current cell ID, or asking the wireless network to provide the client device with its location. Regardless of the method of determining location, the location information is returned in some form after the script is executed. Another known technique involves an element in the network, such as a location server or WAP gateway, which determines a client device's location and places that location within all requests that are assumed to need location information. Determining whether location information is needed is done either by provisioning the location server with URLs of location sites or possibly learning which sites need location information by making them request it. However, current known techniques for establishing location information obtain the location information from a single intermediary, and as a result, tend to be inflexible and limited in nature.

Accordingly, what is needed is an information gathering technique for obtaining and transferring location information that provides a more flexible method of location information collection and transfer.

### BRIEF DESCRIPTION OF THE DRAWINGS

The features of the present invention which are believed to be novel are set forth with particularity in the appended claims. The invention, together with further objects and advantages thereof, may best be understood by making reference to the following description, taken in conjunction with the accompanying drawings, in the several figures of which like reference numerals identify like elements, and wherein:

FIG. 1 is a schematic diagram of a communication network utilizing location information transfer and collection techniques according to the present invention.

FIG. 2 is a schematic diagram of a request for information generated by a WAP client device, according to the present invention.

FIG. 3 is a schematic diagram of a response to a request for information generated by a server device, according to the present invention.

FIG. 4 is a schematic diagram of a location token, according to the present invention.

FIG. 5 is a flow chart of insertion of location information within a location token according to a first preferred embodiment of the present invention.

FIG. 6 is a flowchart of insertion of location information within a location token according to a second preferred embodiment of the present invention.

FIG. 7 is a flowchart of insertion of location information within a location token according to a third preferred embodiment of the present invention.

FIG. 8 is a flowchart of insertion of location information within a location token according to a fourth preferred embodiment of the present invention.

FIG. 9 is a schematic diagram of a location field of a location token, according to the present invention.

### DETAILED DESCRIPTION OF THE PREFERRED EMBODIMENT

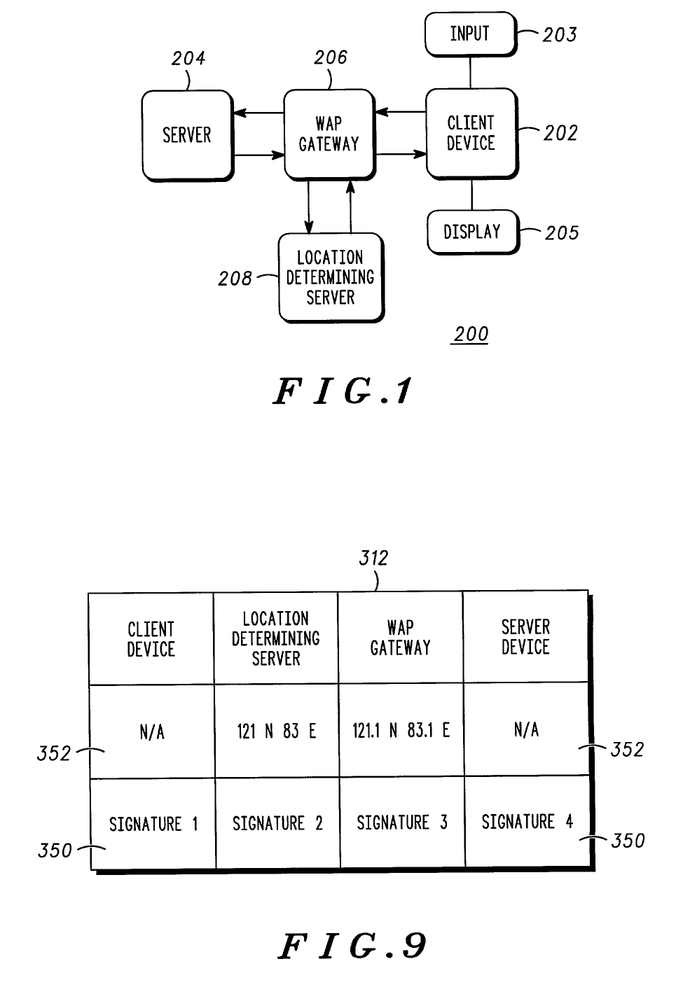

FIG. 1 is a schematic diagram of a communication network utilizing location information transfer and collection techniques according to the present invention. As illustrated in FIG. 1, a communication network 200 includes various intermediaries, such as a WAP client device 202 transmitting information to and receiving information from a server 204 through a WAP gateway 206, for example. A user obtains information from sources along the internet by inputting a request to navigate to a uniform resource locator (URL) associated with the desired information to client device 202 using an input portion 203 of client device 202, such as a keypad, for example. Client device 202 uses the URL to generate and transmit a corresponding request for information to gateway 206, which then decodes the request into a common hypertext transfer protocol (HTTP) request format and transmits the request to server 204. Upon receiving the request, server 204 forms a response that is transmitted to client device 202 through gateway 206.

According to the present invention, a location token, that includes fields for inserting location information related to the geographic position of client device 202 is included within the response from server 204 or within the request from client device 202. Location information is then inserted within location token by any intermediary, including client device 202, gateway 206, and server 204, or any combination thereof. The location information is inserted either by using information available to the respective intermediaries, or by accessing location information from other intermediaries, including a location determining server 208. Location determining server 208 is a mobile location center or a global positioning service, for example. The inserted location information is then utilized to form a response that is displayed on a display 205 portion of client device 202. In this way, the present invention enables the location information to be inserted by any one or combination of the intermediaries 202, 204, 206 and 208 of network 200, in an incremental fashion, and in both directions between server 204 and client device 202, as will be described below.

Although the insertion of location information is described as being performed by client device 202, gateway 206, server 204, or location determining server 208, it is understood that, according to the present invention, insertion of location information is not limited to those devices. As a result, location information could also be inserted by network components other than client device 202, gateway 206, server 204, or location determining server 208, and therefore by a combination of any number of intermediary devices located between and including client device 202 and server 204.

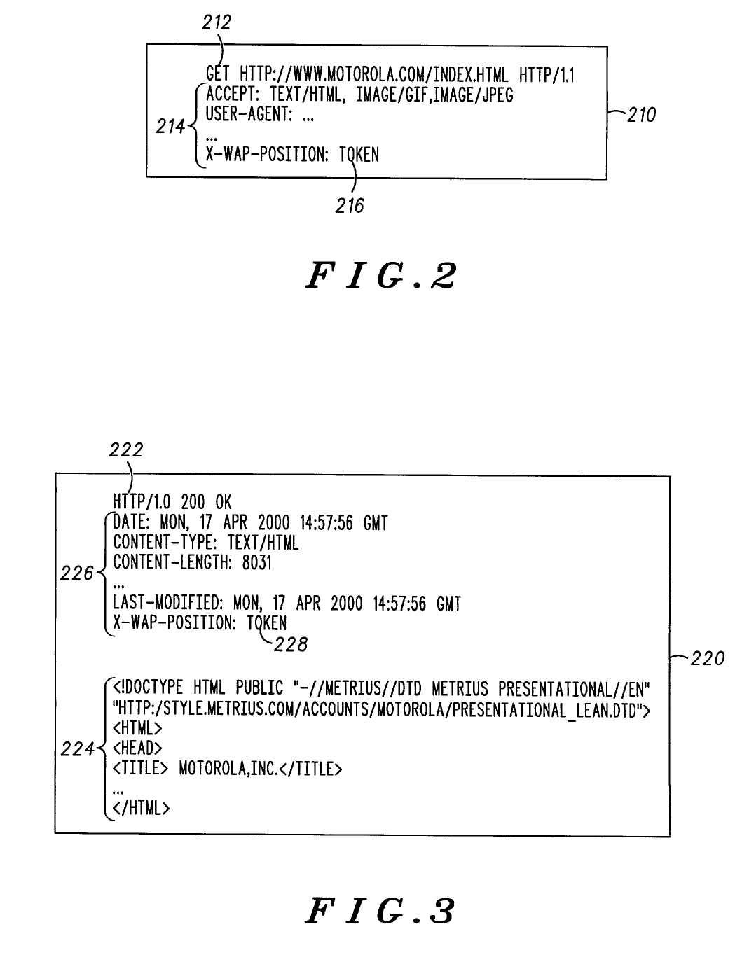

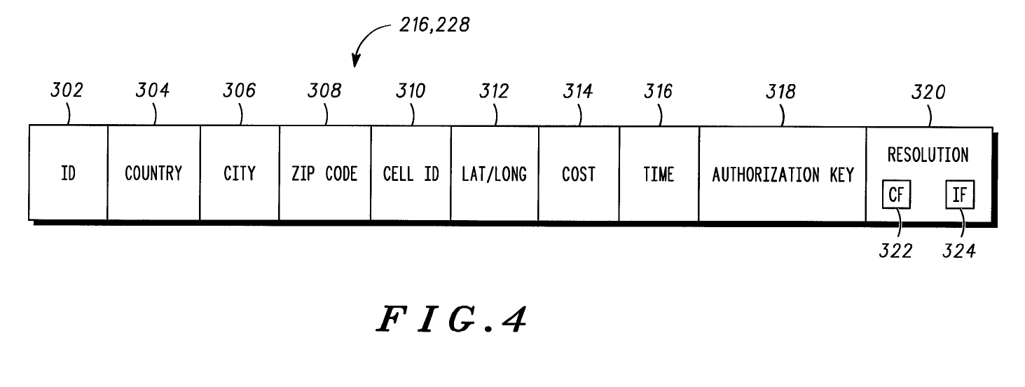

FIG. 2 is a schematic diagram of a request for information generated by a WAP client device, according to the present invention. As illustrated in FIG. 2, a request for information 210 generated by client device 202 includes a request method or command portion 212 containing the URL associated with the desired information, and a request header portion 214, indicating the capabilities of client device 202, along with the type of content that can be displayed by client device 202. According to the present invention, as will be described below, an X-WAP-Position is included in request header portion 214 of request 210 that contains a location token 216 for requesting and transmitting location information between intermediaries 202, 204 206, and 208, and which is shown and described below in reference to FIG. 4.

As illustrated in FIG. 1, according to a first embodiment of the present invention, once the URL input is received from the user, client device 202 utilizes the URL to generate an initial request 210, and transmits request 210 to gateway 206. Gateway 206 decodes request 210 into an HITTP request format and transmits request 210 to server 204, which then generates a response.

FIG. 3 is a schematic diagram of a response to a request for information generated by a server device, according to the present invention. As illustrated in FIG. 3, according to the present invention, a response 220 includes a response status portion 222 containing information related to the status of response 220, a response content portion 224 containing the content of response 220, a response header 226 containing information related to the content of response 220, such as the content type, the content length, and the date when response 220 was last modified, for example, along with an X-WAP-Position containing a location token 228 for requesting location information, shown and described in reference to FIG. 4.

FIG. 4 is a schematic diagram of a location token, according to the present invention. Location token 216, 228, generated respectively by client device 202 and server 204, is generally a data packet that includes some of several possible fields for storing location information and/or location commands. For example, fields associated with location information for locating client device 202 could include, for example, an identification (ID) field 302, a country field 304, a city field 306, a zip code field 308, a cell ID field 310, and a latitude/longitude field 312, while fields for storing location commands include a cost field 314, an authorization key field 318, a location resolution field 320, and, optionally, a time field 316. Cost field 314 indicates the cost of a transaction for obtaining location information, authorization key field 318 indicates whether an entity in the network 200 has write, read, or overwrite authority on the location information in location token 216, 228, and time field 316 indicates the time that location information has been inserted in location token 228. Location resolution field 320 stores commands such as a command requesting other intermediaries to add or complete location information, instructions as to the format of the location information, and instructions relating to how to resolve the location to a particular quality or resolution, as will be described below, using an extended markup language (XML) or text headers.

Location resolution field 320 includes a client device flag (CF) 322 for requesting client device 202 to insert location information within location 216, 228, and an intermediary flag (IF) 324 for requesting all intermediaries 202, 204, 206 and 208 to insert location information within location token 216, 228, as will be described below.

As illustrated in FIGS. 1-4, according to the first preferred embodiment of the present invention, when initially generating response 220 after receiving the request for information from client device, server 204 includes location token 228 in response header 226 of response 220. Server 204 sets client device flag 322 of resolution field 320 of location token 228 to generate a location command requesting client device 202 to insert location information related to client device 202. In addition, particular specifics, such as resolution, format, and so forth, along with service offerings for locating the nearest gas station, for example, are included in response header 226 of response 220. Once generated, response 220 is transmitted from server 204 to gateway 206, which encodes response 220 into a binary representation for transmission to client device 202 and transmits response 220 to client device 202. Client device 202 processes and displays the contents of response 220, including the service offerings for locating the nearest gas station, to the user. The user then selects an appropriate option from the service offerings, and client device 202 generates request 210 based on the option selected.

In generating request 210, client device 202 responds to the location command request indicated by client device flag 322 of resolution field 320 of location token 228 by including location token 216 within the generated request 210. Location token 216 is similar to location token 228 of response 220, shown in FIG.4, and includes fields 302-320 associated with location information for locating client device 202, described above. In addition, it is understood that according to the present invention, location token 216 could be, for example, an update of location token 228, or location token 228 could removed by client device 202, which then generates location token 216 to replace location token 228. Vice versa, in further described embodiments, location token 228 could be an update of location token 216 by server device 204, or could be removed and replaced with location token 228 by server device 204. In either case the location token that is initially generated is designated as the first location token and the updated or second generated location token is designated as a second location token.

According to the present invention, client device 202 includes location and command information available to client device 202 within fields 302-318 of location token 216, and sets intermediary flag 324 of resolution field 320 of location token 216 to generate a location command requesting other intermediates to continue inserting location information within fields 302-320 of location token 216.

For example, according to the present invention, client device 202 inserts the cell identification associated with the current location of client device 202 in cell ID field 302 of location token 216, which is readily available to client device 202 at the time of receipt of location token 228. The resulting generated request 210 is transmitted to gateway 206, which then decodes the generated request 210 into an HTTP request format, responding to the location command request indicated by intermediary flag 324 of resolution field 320 by accessing location information corresponding to client device 202. How gateway 206 obtains the location information will be dependent upon the architecture involved. For example, gateway 206 may access the location information directly from location determining server 208, or may send location token 216 to location determining server 208, which then inserts the location information within location token 216.

Once the location information is inserted within fields 302-320 of location token 216, gateway 206 then transmits the request 210 to server 204, which then generates and transmits an updated response 220 to client device 202 through gateway 206. Updated response 220 includes location token 228, with the location information inserted by client device 202, gateway 206 and location determining server 208 within fields 302-320 of location token 216 inserted within location token 228.

In addition, according to the present invention, depending upon the application constraints desired, server 204 also inserts available location information in location token 216, prior to generating and transmitting the initial or updated response 220 to client device 202, so that response 220 includes the location information inserted by server 204. For example, server 204 inserts available location information by accessing location determining server 208, or transmits location token 228 to location determining server 208, which then inserts the location information within location token 228. Finally, upon receiving the updated response 220, client device 202 displays the requested information to the user through display portion 205.

FIG. 5 is a flow chart of insertion of location information within a location token according to the first preferred embodiment of the present invention. As illustrated in FIGS. 1-5, according to the first preferred embodiment, a user inputs a request to navigate to a uniform resource locator (URL) associated with desired information at an input portion 203 of client device 202. Client device 202 uses the URL to generate corresponding initial request 210, Step 400, which is then transmitted to gateway 206, Step 402. Gateway 206 then decodes request 210 into an HTTP request format and transmits request 210 to server 204, Step 404.

Upon receiving request 210, server 204 generates an initial response 220, Step 406, which includes service offerings for locating the nearest gas stations, for example, along with location token 228. Server 204 sets client device flag 322 of resolution field 320 of location token 228 to generate a location command requesting client device 202 to insert location information related to client device 202. Server 204 then transmits response 220 to gateway 206, which encodes response 220 into a binary representation for transmission to client device 202 and transmits response 220 to client device 202, Step 408. Client device 202 then processes and displays the resulting contents of response 220 through display portion 205, including the service offerings for locating the nearest gas stations, to the user. The user then selects an appropriate option from the service offerings, and client device 202 generates an updated request 210 based on the user selection, such as the request to locate the nearest gas stations, Step 410.

As illustrated in Step 410, when generating updated request 210, client device 202 responds to the location command indicated by client device flag 322 of resolution field 320 of location token 228 by including location token 216 within the generated updated request 210. Client device 202 utilizes the information in fields 302-320 of location token 228 to generate location token 216 of updated request 210, and includes location and command information available to client device 202 within fields 302-318 of location token 216. Client device 202 sets intermediary flag 324 of resolution field 320 of location token 216 to generate a location command requesting other intermediates to continue inserting location information within fields 302-320.

For example, according to the present invention, client device 202 inserts the cell identification associated with the current location of client device 202 in cell ID field 302 of location token 216, which is readily available to client device 202 at the time of receipt of location token 228. The generated request 210, including location token 216, is transmitted by client device 202 to gateway 206, Step 412, which then decodes the generated request 210 into an HTTP request format, responding to the location command indicated by intermediary flag 324 of resolution field 320 by accessing location information corresponding to client device 202 from location determining server 208, for example. Once location information is inserted within location token 216, gateway 206 then transmits request 210 to server 204, Step 414, which generates and transmits an updated response 220 to client device 202 through gateway 206, using the location information inserted by client device 202 and gateway 206 within fields 302-320 of location token 216, Step 416.

As described above, server 204 may also insert available location information within location token 228, prior to transmitting the response 220 to client device 202 in Step 406 or in Step 416, including location information obtained from location determining server 208. Finally, upon receiving the updated response 220, client device 202 displays the requested information to the user through display portion 205.

According to a second preferred embodiment of the present invention, once initial request 210 is received by server 204 from client device 202 through gateway 206, server 204 generates an initial response 220, including location token 228. However, according to the second embodiment, server 204 sets intermediary flag 324 of resolution field 320 of location token 228 in initial response 220 to generate a location command requesting intermediaries 202, 206 and 208 to insert location information related to client device 202. Server 204 then transmits response 220 to gateway 206.

In addition, server 204 may also insert information within location token 228 that is available to server 204, which, depending upon the application constraints desired, includes accessing location determining server 208 to obtain location information, or transmitting location token 228 to location determining server 208 which would then insert the location information.

According to the second preferred embodiment, gateway 206 encodes response 220 into a binary representation for transmission to client device 202, responding to the location command request indicated by intermediary flag 324 of resolution field 320 of location token 228 by accessing location information from location detecting server 208 or transmitting location token 228 to location determining server 208, for example. Once location information is inserted within location token 228, gateway 206 then transmits the resulting response 220 to client device 202.

Upon receiving response 220, client device 202 generates an updated request 210, including the location information inserted in location token 228 by server 202, gateway 204 and location determining server 208. In addition, according to the second preferred embodiment of the present invention, client device 202 responds to the location command indicated by intermediary flag 324 of resolution field 320 of location token 228 by inserting location information in location token 216. For example, client device 202 inserts the cell ID in cell ID field 310 of location token 228. Client device 202 does not set intermediary flag 324 of location token 216 and generated request 210 is then transmitted to server 204 through gateway 206.

Server 204 generates an updated response 220, utilizing the location and command information within location token 216, and transmits response 220 to client device 202 through gateway 206. Finally, upon receiving response 220, client device 202 displays the resulting requested information to the user through display portion 205.

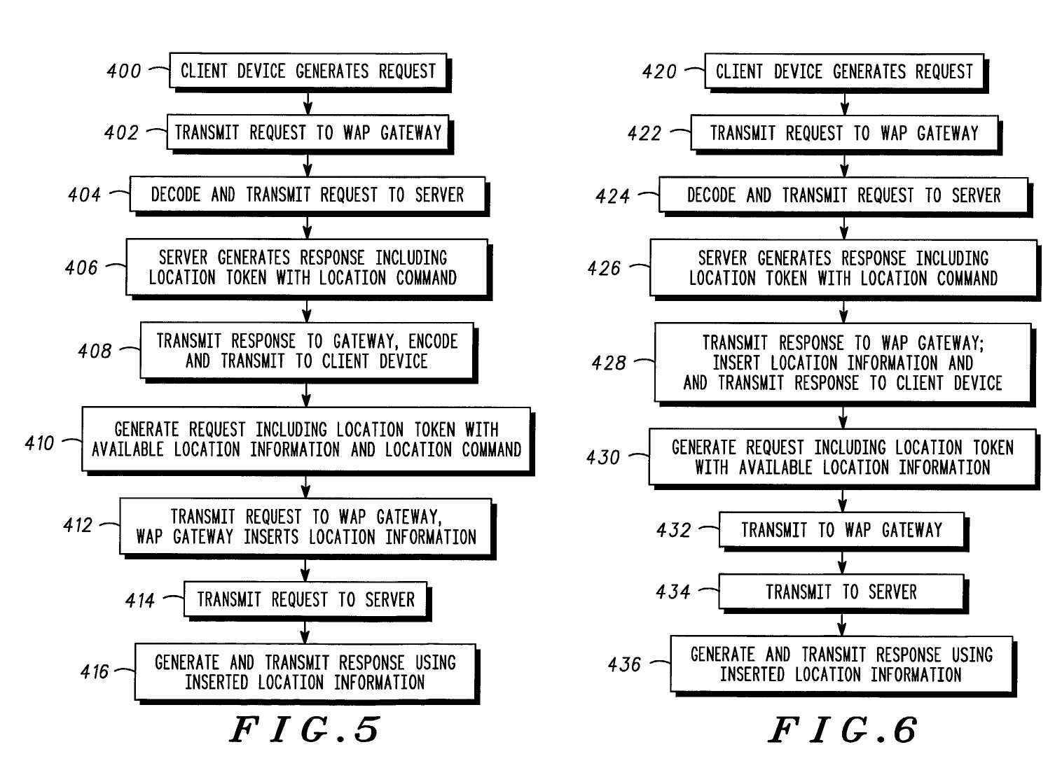

FIG. 6 is a flowchart of insertion of location information within a location token according to the second preferred embodiment of the present invention. As illustrated in FIG. 6, according to the second preferred embodiment, client device 202 utilizes the URL input by the user to generate corresponding initial request 210, Step 420, and transmits request 210 to gateway 206, Step 422. Gateway 206 then decodes request 210 into an HTTP request format and transmits request 210 to server 204, Step 424. Upon receiving request 210, server 204 generates an initial response 220, including location token 228, setting intermediary flag 324 of resolution field 320 of location token 228 to generate a location command requesting intermediaries 202, 206 and 208 to insert location information, Step 426. Depending upon the application constraints desired, server 204 also inserts location information in location token 228 that is available to sever 204. In addition, for example, server 204 inserts available location information by accessing location determining server 208 for location information, or transmitting location token 228 to location determining server 208 which then inserts the location information within location token 228.

Response 220 is then transmitted from server 204 to gateway 206, Step 428, which encodes response 220 into a binary representation for transmission to client device, responding to the location command indicated by intermediary flag 324 of resolution field 320 of location token 228 by accessing location information corresponding to client device 202 from location determining server 208, for example, Step 428. Once location information is inserted within location token 228, gateway then transmits response 220 to client device 202, Step 428.

Client device 202 processes and displays the resulting contents of response 220 to the user through display 205. Once the user selects an appropriate option from the service offerings, client device 202 generates an updated request 210, and includes the location and command information from fields 302-320 of location token 228 in location token 216, Step 430. In addition, client device 202 responds to the location command indicated by intermediary flag 324 of resolution field 320 of location token 228 by inserting available location information in location token 216 in Step 430, such as cell ID in cell ID field 310 of location token 228, for example, so that location token 216 of request 210 includes the location information inserted by client device 202.

Client device 202 does not set intermediary flag 324 of location token 216 and transmits the generated request 210 to server 204 through gateway 206, Steps 432 and 434. Finally, server 204 generates an updated response 220, using the location and command information inserted in fields 302-320 of location token 216, and transmits response 220 to client device 202 through gateway 206, Step 436. The requested information is then displayed to the user by client device 202 through display portion 205.

According to a third preferred embodiment of the present invention, once client device 202 receives the URL initially input by the user, client device 202 utilizes the URL to generate an initial request 210. However, according to the third preferred embodiment of the present invention, client device 202 also includes location token 216 within initial request 210, and inserts location information within location token 216 that is available to client device 202, such as cell ID field 312, for example. Client device 202 then transmits generated request 210 to gateway 206, which then decodes request 210 into an HITP request format and transmits request 210 to server 204.

Upon receiving request 210, server 204 generates response 220, including location token 228 with information inserted within location token 216 by client device 202. According to the present invention, depending upon the application constraints desired, server 204 inserts location information that is available to server 204 within fields 302-320 of location token 216. In addition, for example, server 204 inserts available location information by accessing location determining server 208 for location information, or transmitting location token 228 to location determining server 208 which then inserts location information within location token 228. In this way, server 204 utilizes the information inserted by client device 202 and server 204 within fields 302-320 of location token 216 to generate location token 228 within response 220.

Server 204 also sets intermediary flag of resolution field 320 of location token 228 to generate a location command requesting other intermediaries to continue inserting location information within location token 228. The generated response 220 is transmitted to gateway 206, which encodes response 220 into a binary representation for transmission to client device 202, responding to the location command indicated by intermediary flag 324 of resolution field 320 by accessing location information corresponding to client device 202 from location determining server 208, for example. Gateway 206 inserts available location information in location token 228, including the location information obtained from location determining server 208, along with appropriate command information, within corresponding fields 302-320 of location token 228. Gateway 206 then transmits response 220 to client device 202, which displays the resulting requested information to the user through display 205.

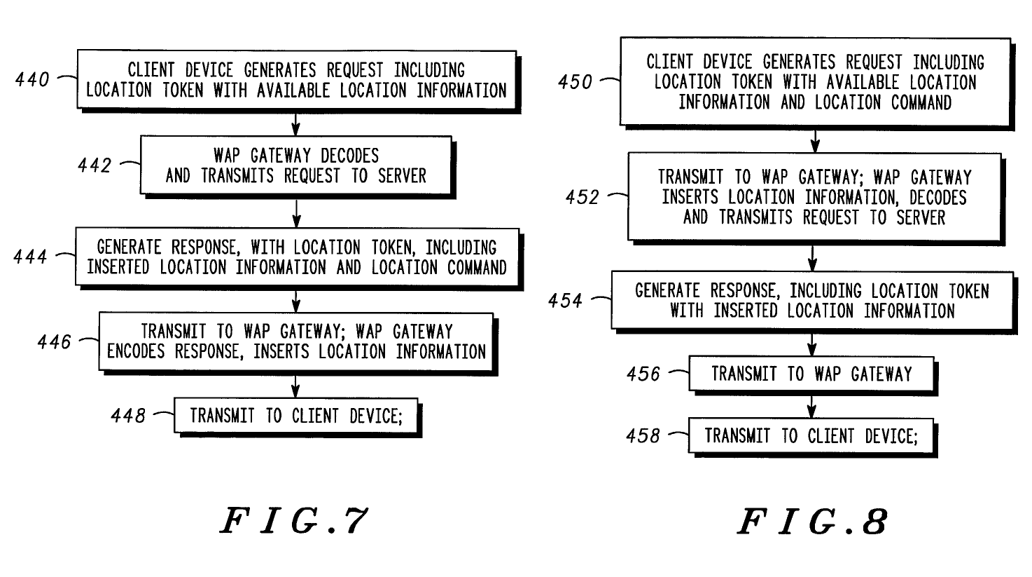

FIG. 7 is a flowchart of insertion of location information within a location token according to the third preferred embodiment of the present invention. As illustrated in FIG. 7, upon receiving the URL initially input by the user, client device 202 utilizes the URL to generate an initial request 210. However, according to the third preferred embodiment of the present invention, client device 202 includes location token 216 within initial request 210, inserting information of location token 216 available to client device 202, such as cell ID field 312, for example, Step 440. Client device 202 then transmits request 210 to gateway 206, which decodes request 210 into an HTTP request format and transmits request 210 to server 204, Step 442.

As illustrated in Step 444, server 204 generates response 220, including location token 228 with location information that was inserted within location token 216 by client device 202. According to the present invention, depending upon the application constraints desired, server 204 inserts location information available to server 204 within fields 302-320 of location token 216. In addition, for example, as described above, server 204 also inserts available location information by accessing location determining server 208 for location information, or transmitting location token 228 to location determining server 208, which then inserts location information within location token 228. Server 204 therefore utilizes location information inserted by client device 202 and server 204 within location token 228 of response 220. Server 204 also sets intermediary flag 324 of resolution field 320 of location token 228 to generate a location command requesting other intermediaries 206, 208 to continue inserting location information within location token 228.

The generated response 220 is transmitted to gateway 206, Step 446, which encodes response 220 into a binary format for transmission to client device 202, responding to the command request indicated by intermediary flag 324 of resolution field 320 by accessing location information corresponding to client device 202 from location determining server 208, for example. Gateway 206 inserts location information within location token 228 that is available to gateway 206, including location information obtained from location determining server 208, along with appropriate command information, within associated fields 302-320 of location token 228. Gateway 206 transmits response 220 to client device 202, Step 448, which then displays the resulting requested information to the user through display 205.

According to a fourth preferred embodiment of the present invention, upon receiving the URL initially input by the user, client device 202 utilizes the URL to generate an initial request 210, including location token 216. Client device 202 inserts location information within location token 216 that is available to client device 202, such as cell ID field 312, for example. However, according to the fourth preferred embodiment of the present invention, client device 202 also sets intermediary flag 324 of resolution field 320 of location token 216 to generate a location command requesting other intermediaries 204, 206 and 208 to continue inserting location information related to client device 202 within location token 216. Client device 202 then transmits request 210 to gateway 206.

Gateway 206 decodes request 210 into an HITP format, responding to the location command indicated by intermediary flag 324 of resolution field 320 by accessing location information related to client device 202 from location detecting server 208, for example, and inserting available information, including the location information obtained from location determining server 208, along with appropriate command information, within fields 302-320 of location token 216. Gateway 206 then transmits request 210 to server 204.

Upon receiving request 210, server 204 generates response 220, including location token 228 with location information that was inserted by client device 202, gateway 206 and location determining server 208. In addition, server 204 responds to the location command indicated by intermediary flag 324 of resolution field 320 of location token 216 by inserting location information available to server 204 within appropriate fields 302-320 of location token 228. Server 204 then transmits response 220 to client device 202 through gateway 206, which then displays the requested information to the user through display 205.

FIG. 8 is a flowchart of insertion of location information within a location token according to the fourth preferred embodiment of the present invention. As illustrated in FIG. 8, according to a fourth preferred embodiment of the present invention, upon receiving the URL initially input by the user, client device 202 utilizes the URL to generate an initial request 210, Step 450. Client device 202 includes location token 216 within initial request 210 in Step 450, inserting location information within location token 216 that is available to client device 202, such as cell ID field 312, for example. However, according to the fourth preferred embodiment of the present invention, client device 202 also sets intermediary flag 324 of resolution field 320 of location token 216 in Step 450 to generate a location command requesting other intermediaries 204, 206 and 208 to continue inserting location information related to client device 202 within location token 216. Client device 202 then transmits request 210 to gateway 206, Step 452.

Gateway 206 decodes request 210 into an HTTP format, responding to the location command indicated by intermediary flag 324 of resolution field 320 by accessing location information related to client device 202 from location detecting server 208, for example, and inserting available information, including the location information obtained from location determining server 208, along with appropriate command information, within fields 302-320 of location token 216, Step 452. Gateway 206 then transmits request 210 to server 204.

Upon receiving request 210, server 204 generates response 220, including location token 228 with location information that was inserted by client device 202, gateway 206 and location determining server 208. In addition, server 204 responds to the location command indicated by intermediary flag 324 of resolution field 320 of location token 216 by inserting location information available to server 204 within appropriate fields 302-320 of location token 228, Step 454. Server 204 then transmits response 220 to client device 202 through gateway 206, Steps 456 and 458, which then displays the requested information to the user through display 205.

Although, in the description of the preferred embodiments set forth above, client device 202 is described as being informed of the location command requesting location related to client device 202 by client device flag 322 or intermediary flag 324 of resolution field 320 being set in response 220 from server 204, indication of the location command could, in the alternative, be made merely by the inclusion of location token 228 in response 220 by server 202. For example, in Step 406 of FIG. 5, server 204 generates response 220, including location token 228, which then itself serves as a location command requesting client device 202 to insert location information. As a result, when generating updated request 210 in Step 410, the location command is indicated by the inclusion of location token 228 within response 220. In this way, by having inclusion of location token 228 in response 220 serve as the location command, the use of client device flag 322 can be eliminated, so that the location information is inserted by intermediaries 202-208 in response to receiving location token 216, 228.

FIG. 9 is a schematic diagram of a location field of a location token, according to the present invention. According to the present invention, in addition to the location information that is inserted, each of fields 302-320 of location token 216, 228 includes signature codes identifying the intermediary providing the information in the field. For example, as illustrated in FIG. 9, latitude/longitude field 312 includes location information 352 inserted by location determining server 208 and gateway 206, along with corresponding signature codes 350 to identify the intermediary providing the location information. Although signature codes 350 and location information 352 are illustrated in FIG. 9 for latitude/longitude field 312, it is understood that, according to the present invention, signature codes 350 and location information 352 are included in the same way in each of fields 302-320, and therefore a separate description for each of fields 302-320 has been omitted for brevity.

In this way, according to the present invention, as location token 216, 228 is transmitted between intermediaries 202-208, information inserted by each of the intermediaries is contained, along with a signature to identify the intermediary responsible for the inserted location information, within each field 302-320 as the information is resolved. As a result, according to a preferred embodiment of the present invention, each of fields 302-320 may include location information inserted by one or more than one of intermediaries 202-208, for example, or may include no inserted location information if the field is not resolved. However, it is understood that any hierarchy of intermediaries may also be used for inserting location information 352, so that, for example, in the alternative only information from the entity with the highest authorization level is contained within each of fields 302-320.

According to the first embodiment of the present invention, for example, as location token 216 is transmitted from client device 202 to server 204 through gateway 206, Steps 410-416, location information 352 is inserted by intermediaries 202-208 within one or more of fields 302-320, along with corresponding signature codes 350 for each field in which information was inserted. In the same way, according to the second preferred embodiment, as location token 228 is transmitted from server 204 to client device 202 through gateway 206, Steps 426-430, location information 352 is inserted by intermediaries 202-208 within one or more of fields 302-320, along with corresponding signature codes 350 for each field in which information was inserted.

In addition, according to the third and fourth preferred embodiments, as location token 216 is transmitted from client device 202 to server 204 through gateway 206, Steps 440, 442 and Steps 450, 452, respectively, and as location token 228 is transmitted from server 204 to client device 202, Steps 44-448 and 454-458, respectively, location information is inserted by intermediaries 202-208, along with corresponding signature codes 350 for each field in which information was inserted, so that insertion of location information is performed incrementally in both directions between client device 202 and server 204.

By allowing any of intermediaries 202-208 to insert information, the present invention allows end-to-end optimization to be introduced. For example, server 204 does not have to include location token 228, since the system could define a policy where each request made by client device 202 includes location information, regardless of whether server 204 requested the information or not. The system, in this case, could merely deploy a filter that strips unwanted or unauthorized location tokens before they reach server 204.

The present invention allows more intermediaries to be introduced, enables insertion of location information to be done by more than just one single intermediary, and enables insertion of location information to be incremental as the location token moves from end to the next, i.e., from client device 202 to server 204 and vice versa. For example, one intermediary may perform verification on privileges, one on location, and yet another on formatting and resolution.

By abstracting where insertion of location information is performed, and allowing an incremental solution to be put in place, the present invention eliminates the necessity for network systems to introduce additional functionality to provide a complete solution by enabling functionality to be leveraged at an appropriate point that optimizes cost and throughput. Rather, the present invention enables implementation to vary dynamically depending on network characteristics and server loads. For example, a system that normally inserts location information on the path between server 204 and client device 202 may opt to defer insertion of location information if the service is overloaded at the time of the initial attempt.

The system may also be varied depending upon certain constraints, such as the cost of obtaining the location information indicated in cost field 314, or the time of the measurement indicated in time field 316 of location token 216, 228. For example, a certain cost amount limit could be placed within cost field 314, so that intermediaries 202-208 determine whether to provide the requested location information if the cost of doing so is less than the cost limit indicated. In this way, the present invention enables the cost for obtaining location information from each of intermediaries 202-208 to be controlled. In addition, each time an intermediary provides location information, the cost of doing so can also be subtracted from the indicated cost limit so that the total cost as the location tokens 216, 228 move between intermediaries 202-208 can be also be controlled. In the same way, constraints such as time or resolution can be used, so that whether each of intermediaries 202-208 inserts location information can be controlled based on the time or the available resolution, or insertion of location information can be performed by the intermediary best fit to do so.

The present invention, therefore, allows implementation of the insertion of location information to be dynamically dependent on network characteristics and server loads, and as a result, provides a more flexible method of location collection and transfer.

While particular embodiments of the present invention have been shown and described, modifications may be made. It is therefore intended in the appended claims to cover all such changes and modifications that fall within the true spirit and scope of the invention.

What is claimed is:

1. A communication network, comprising:
a plurality of intermediaries generating and transmitting a request for information and a response to the request; and
a location token requesting location information corresponding to the first intermediary and transmitted between the plurality of intermediaries within the request and the response.

2. The communication network of claim 1, wherein the location information is inserted within the location token in response to receipt of the location token by one or more of the plurality of intermediaries.

3. The communication network of claim 2, wherein the location token includes signature codes corresponding to location information inserted within the location token.

4. The communication network of claim 1, wherein the location information is incrementally inserted by one or more of the plurality of intermediaries.

5. The communication network of claim 1, the plurality of intermediaries including a first intermediary and a second intermediary, wherein the plurality of intermediaries other than the first and the second intermediary are between the first and the second intermediary, and wherein the location information is inserted in both directions between the first intermediary and the second intermediary by one or more of the plurality of intermediaries.

6. The communication network of claim 1, further comprising a location command requesting the location information, the location command positioned within the location token, wherein the location information is inserted within the location token by one or more of the plurality of intermediaries in response to the location command.

7. A communication network, comprising:
a first intermediary generating and transmitting a request for information;
a second intermediary generating a first response to the request, the first response including a first location token requesting location information corresponding to the first intermediary; and
a third intermediary between the first and the second intermediary, wherein the first response is transmitted between the first intermediary and the second intermediary through the third intermediary.

8. The communication network of claim 7, wherein the first location token includes a first location command requesting insertion of location information within the location token by either the first intermediary or by both the first and the third intermediary.

9. The communication network of claim 8, wherein the first intermediary generates a second location token including location information available to the first intermediary in response to the first location command, the second location token including a second location command requesting insertion of location information within the second location token, and wherein the third intermediary inserts location information available to the third intermediary in response to the second location command, and the second intermediary generates and transmits a second response to the first intermediary through the third intermediary, the second response including the location information inserted within the second location token by the first and the third intermediary.

10. The communication network of claim 9, wherein the second location token is an update of the first location token.

11. The communication network of claim 9, wherein the first and the second location token include signature codes corresponding to the intermediary inserting location information.

12. The communication network of claim 9, wherein the second intermediary inserts location information available to the second intermediary within the second response.

13. The communication network of claim 9, wherein the second intermediary inserts location information available to the second intermediary within the first response.

14. The communication network of claim 8, wherein, in response to the first location command, the third intermediary inserts location information available to the third intermediary within the first location token and the first intermediary generates a second location token, including the location information inserted by the third intermediary and location information available to the first intermediary, and wherein the second intermediary generates and transmits a second response to the first intermediary through the third intermediary, the second response including the location information inserted within the updated location token.

15. The communication network of claim 14, wherein the first and the second location token include signature codes corresponding to the intermediary inserting location information.

16. The communication network of claim 14, wherein the second intermediary inserts location information available to the second intermediary within the second response.

17. The communication network of claim 14, wherein the second intermediary inserts location information available to the second intermediary within the first response.

18. The communication network of claim 14, wherein the second location token is an update of the first location token.

19. A communication network, comprising:
a first intermediary generating and transmitting a request for information, the request including a first location token requesting location information corresponding to the first intermediary;
a second intermediary generating a response to the request, the response including a second location token; and
a third intermediary, between the first and the second intermediary, transmitting the request and the response between the first and the second intermediary, wherein the first intermediary includes location information available to the first intermediary within the first location token, and the second intermediary includes location information previously inserted within the first location token in the second location token.

20. The communication network of claim 19, wherein the second location token is an update of the first location token.

21. The communication network of claim 19, wherein the third intermediary inserts location information within second location token as the response is transmitted from the second intermediary to the first intermediary.

22. The communication network of claim 19, wherein the second intermediary inserts location information available to the second intermediary within the second location token.

23. The communication network of claim 19, wherein the third intermediary inserts location information within the first location token as the request is transmitted from the first intermediary to the second intermediary.

24. The communication network of claim 19, wherein the first and the second location token include signature codes corresponding to the intermediary inserting location information.

25. A method for transferring and collecting location information in a communication network, comprising the steps of:
generating a request for information at a first intermediary;
transmitting the request to a second intermediary through a third intermediary;
generating a response to the request for information; and
transmitting a first location token between the first, second and third intermediaries requesting insertion of location information corresponding to the first intermediary.

26. The method of claim 25, further comprising the step of inserting signature codes identifying the intermediary inserting the location information.

27. The method of claim 25, wherein the first location token is transmitted within the response and includes a location command requesting insertion of the location information by the first intermediary, the method further comprising the steps of:
transmitting the response to the first intermediary through the third intermediary;
generating a second location token in response to the location command, the second location token including location information available to the first intermediary and a second location command requesting insertion of location information within updated location token;
transmitting the second location token from the first intermediary to a third intermediary;
inserting location information available to the third intermediary within the second location token and transmitting the second location token from the third intermediary to the second intermediary; and
generating an updated response to the request for information using the location information inserted by the first and third intermediaries and transmitting the updated response to the first intermediary through the third intermediary.

28. The method of claim 27, wherein the second location token is an update of the first location token.

29. The method of claim 25, wherein the first location token is transmitted within the response and includes a location command requesting insertion of the location information by the first intermediary and the third intermediary, the method further comprising the steps of:
transmitting the response to the third intermediary;
inserting location information available to the third intermediary within the first location token and transmitting the response from the third intermediary to the first intermediary;
generating an updated request including a second location token including location information inserted by the third intermediary along with location information available to the first intermediary;
transmitting the updated request from the first intermediary to the second intermediary through the third intermediary; and
generating an updated response to the request for information using the location information inserted by the first and third intermediaries within the second location token and transmitting the updated response to the first intermediary through the third intermediary.

30. The method of claim 29, wherein the second location token is an update of the first location token.

31. The method of claim 25, wherein the first location token is transmitted within the request, along with location information available to the first intermediary, the method further comprising the steps of:
generating a second location token to be included in the response, the seond location token including location information inserted by the first intermediary and location information available to the second intermediary, along with a location command requesting the third intermediary to insert location information within the second location token;
transmitting the response to the third intermediary; and
inserting location information available to the third intermediary within the second location token and transmitting the response from the third intermediary to the first intermediary.

32. The method of claim 31, wherein the second location token is an update of the first location token.

33. The method of claim 25, wherein the first location token is transmitted within the request and includes a location command requesting insertion of the location information by the second and third intermediaries, along with location information available to the first intermediary, the method further comprising the steps of:
transmitting the request to the third intermediary;
inserting location information available to the third intermediary within the first location token and transmitting the request from the third intermediary to the second intermediary;
generating a second location token to be included in the response, the second location token including location information inserted by the first and third intermediaries and location information available to the second intermediary; and
transmitting the response to the first intermediary through the third intermediary.

34. The method of claim 33, wherein the second location token is an update of the first location token.
